(19) United States
(12) Patent Application Publication
(10) Pub. No.: US 2008/0054654 A1
(43) Pub. Date: Mar. 6, 2008

(54) Safer Car

(76) Inventor: Shah Ashokkumar Dahyabhai, Ahmedabad (IN)

Correspondence Address: OCCHIUTI ROHLICEK & TSAO, LLP, 10 FAWCETT STREET, CAMBRIDGE, MA, 02138, US

(21) Appl. No.: 11/573,763

(22) PCT Filed: Aug. 10, 2005
(86) PCT No.: PCT/IN05/00271

§ 371 Date: Feb. 15, 2007

(30) Foreign Application Priority Data
Aug. 16, 2004 (IN) 884/MUM/2004

(51) Int. Cl. B60R 19/32; B60R 19/36; B60R 21/00

(52) U.S. Cl. 293/124; 280/727; 293/134; 293/155

(57) ABSTRACT

SAFER CAR is invented to provide maximum safety to the car users and reduce riders injuries in invent of the motor vehicle collision. SAFER CAR it consists of front bumper (1), strong passenger cabin (3), airbag (37), head belt (44) and seatbelt (50). Front bumper (1) is provided with strong spring (12) and hydraulic shock absorbers (16 & 17), which reduces the shock of the impact of frontal crash. The strongbox passenger cabin (3) is provided impact beam, which provided protection to the passengers or cargo from all the direction. The use of safer Co2 gas and perforated airbags (37) enhance the safety of the passengers. The headband (44) and seatbelt (50) is provides with better protection during the car drive. In the event of a frontal crash, all the brakes are released by the middle rod (9) and the pair of the strong spring (12) pushes the car back.

### BACKGROUND ART

Though it is named ‘SAFER CAR’ many of its innovative and novel safety features are applicable to bigger vehicles carrying passengers and cargo to reduce rider's injuries in the event of a motor vehicle collision. This includes buses and trucks also.

Since decades people use the car as the most popular vehicle of transport. Due to lack of adequate safety features, thousands of people loose their lives and limbs in accidents. Generally frontal crashes are most fatal as cars travel in the front direction with a great speed. When there is a collision, there is nothing between the car and the other object; it may be another car coming from the opposite directions or a stationary object like tree or a wall. When two cars coming from the opposite collide, the velocity of the crash is the addition of the speeds of both the cars. When a car hits another car from the back, the velocity of the crash is the subtraction of their speeds. In a sideways crash also only the speed of the hitting vehicle counts, so a frontal crash is the most harmful. In this invention strong front bumper is separated from the car chassis by a pair of strong springs and hydraulic shock absorbers. In the event of a crash, the springs and the hydraulic shock absorbers nullify most of the shock. Another novel feature of the SAFER CAR is that its brakes are released when there is a crash, so the car rolls back by the push of its strong springs. This reduces the crushing of the car body. The passenger cabin is made of a strongbox with impact beams on all the four sides and also at bottom and the top. For airbags a safer Co₂ (carbon dioxide) gas is used. The airbags are perforated in such a way that an inflated airbag is automatically deflated within 5-10 seconds. This reduces the risk of suffocation to the passengers. In the event of a frontal crash the torso of passengers in held back by the seat belt but the head jerks forward with a great speed, which may be fatal. In SAFER CAR a headband is provided which is attached by Velcro fastener to a stretchable hand, stitched to the headrest. In seat belt also the use of Velcro fasteners is indicated. It makes opening of the seatbelt quick in case of emergency.

### BRIEF DESCRIPTION OF DRAWINGS

The present invention addresses the safety drawbacks of the conventional car and will be described with greater specific and clarity with reference to the following drawings.

FIG. 1 represents top view of the safer car.

FIG. 2 represents top view of the front bumper.

FIG. 3 represents the side view of the brackets on the inside of the front bumper.

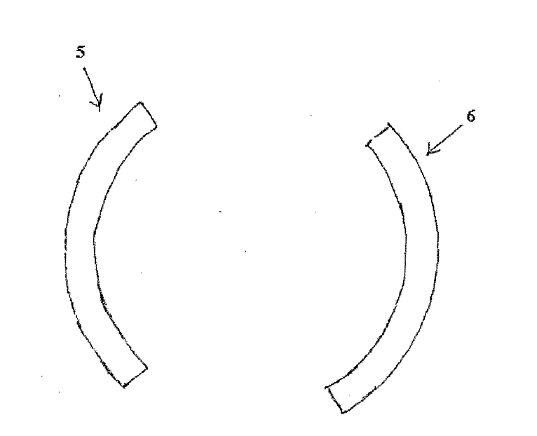

FIG. 4 represents top view of the spring attached to the front bumper and the hydraulic shock absorber encased inside the spring and attached to the chassis of the car.

FIG. 5 represents top view of the strongbox passenger cabin.

FIG. 6 represents side view of the middle impact beam of the passenger cabin.

FIG. 7 represents the side view of the door.

FIG. 8 represents the side view of the dashboard side of the airbag.

FIG. 9 represents the side view of the safety headband.

FIG. 10 represent the side view of the stretchable band, stitched to the backside of the headrest.

FIG. 11 represents the top view of the safety seat belt.

### DISCLOSURE OF INVENTION

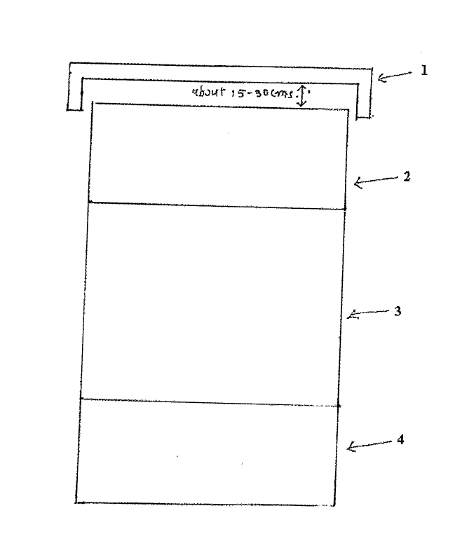

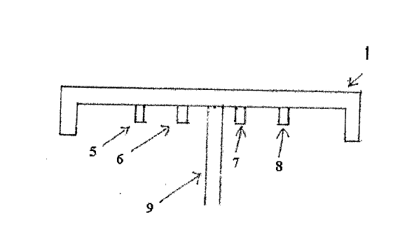

Referring FIG. 1, Front bumper (1) has distance of 15-30 cros with front part (2) of the car, which is the hood of the car and it is supported by two hydraulic shock absorbers (16 & 17). This arrangement effectively absorbs the shock of a collision. It has battery, engine radiator etc. on the upper side and chassis at the bottom. Front part (2) is followed by the strongbox passenger cabin (3) which in turn is followed by the backside of the car (4). FIG. 2 represents top view of the front bumper, which is made of a strong steel plate. It is hen' at 900 angles on both the ends to protect the sides of the car.

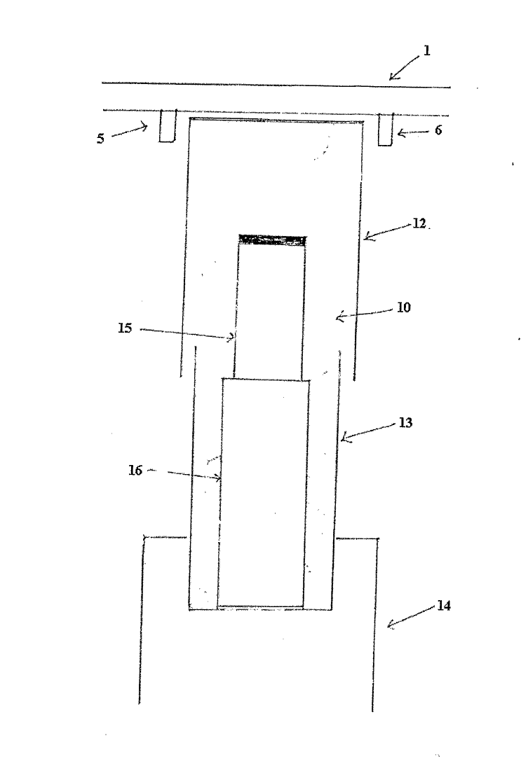

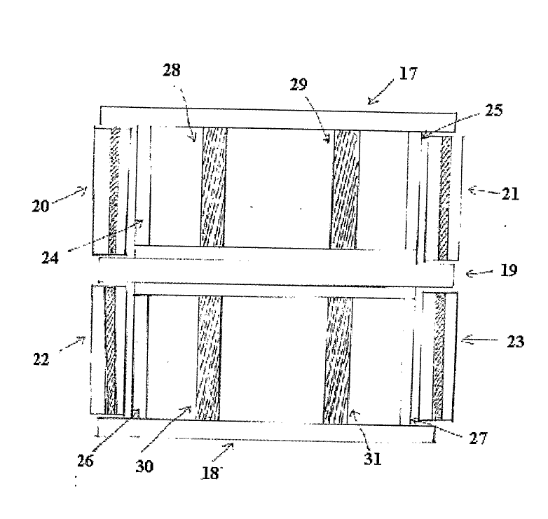

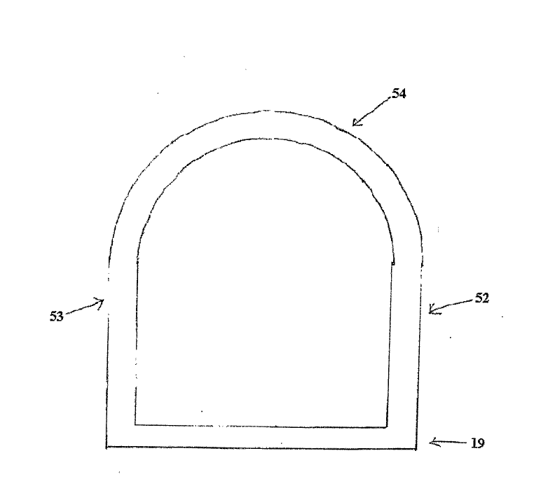

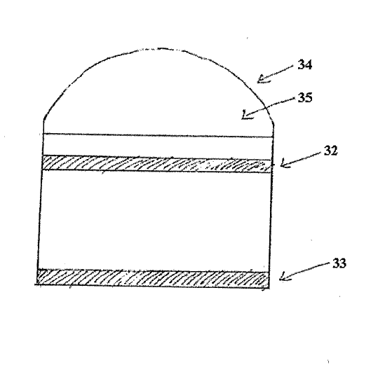

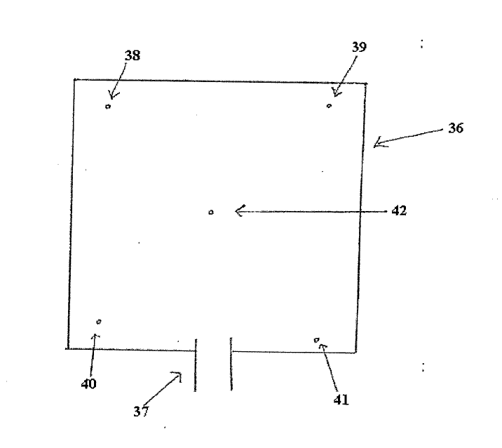

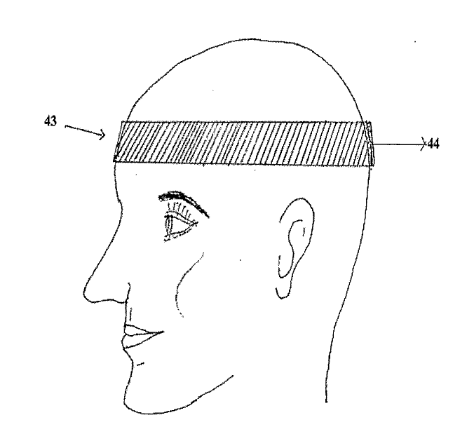

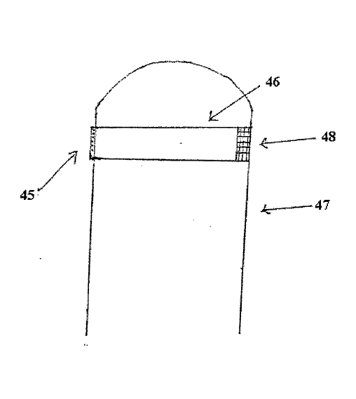

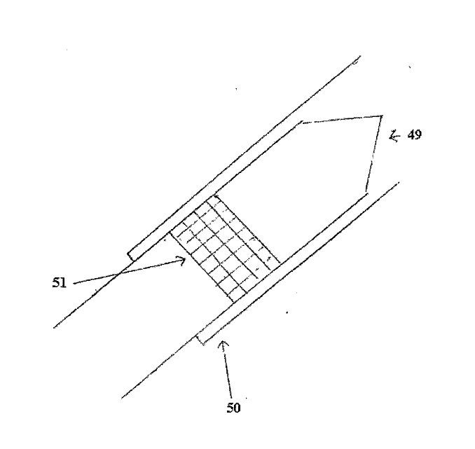

It has brackets (5, 6, 7 & 8). One strong spring (12) is put between the brackets (5 & 6) and other spring (12) is put between the brackets (7 & 8). A strong rod (9) is attached in middle of the bumper (I) on the inside. Upon the traveling of the bumper (I) to inside the rod (9) is pushed in and it releases all the brakes of the car when the push bumper (I) is pushed back upon a collision. The strong springs (12) are strong enough to push the car back by the power of their expansion so, the car rolls back and it is saved from further damage. This can be done mechanically or electrically according to the design of the car and the brakes. Rod (9) pushes in a lever that releases Coe gas from a cylinder filled with liquid Co₂. This gas instantly inflates the airbags. Side view of brackets (10 & 11) are attached inside of front bumper (1). This brackets (10 & 11) encases the strong spring (12) and the cylinder (13) covering the spring (12). The top view of the bumper (1) with spring (12) and hydraulic shock absorber is shown in FIG. 4. This pair of brackets (10 & 11) encases the cylinder (13), which holds a strong spring (12) inside it. The other end of spring (12) is attached to cylinder (14). The other cylinder (14) is also connected with chassis (15) of the car. Lower part of hydraulic shock absorber (16) is also attached to cylinder (14) at the bottom. Upon a front collision, bumper (1) pushes the strong spring (12) and travels some distance before touching the upper part of the hydraulic shock absorber (17). Now the bumper (1) travels back under joint resistance of spring (12) and hydraulic shock absorber (16 & 17). As the shock of the impact is nullified by spring (12) and hydraulic shock absorber (16 & 17). The spring (12) starts expanding and after expanding the spring (12) & hydraulic shock absorber (16 & 17) also returns to its original place. This push of the strong spring (12) makes the SAFER CAR to roll back as its wheels are free and all brakes released. This prevents further crushing of the car body. Top view of the strongbox passenger cabin (3) is represents in FIG. 5. It has front impact beam (18) rear impact beam (19), middle impact beam (20), side impact (21,22, 23 & 24). Each door has one impact beam (25,26,27& 28) at the bottom as shown in FIG. 5 and another impact beam at middle level. The strongbox is attached to the chassis of the car by plates (29, 30, 31 & 32). Side view of the middle impact beam (20) of the strongbox is shown in FIG. 6. It has vertical impact (53) on one side and vertical impact beam (54) on the other side. It has arch shaped top impact beam (55) at the roof of the car. This gives protection to the cabin in the car turning upside down. Side view of the single door is represented in FIG. 7. It has two impact beams (33) at middle height and (34) at the bottom height. Top frame of the door is represented by (35) and glass window (36) is fitted in it. FIG. 8 represents side view of the airbag (37) is showing in its dashboard side. It has a pipe (38) at the bottom to allow the Co= gas to enter into the airbag and inflate it. It has small holes (39, 40, 41,42 & 43) to allow the pressurized gas to be released slowly so that the inflated airbag (37) deflates automatically within 5-10 seconds of inflation. This eliminates the risk of the suffocated by the airbags. Side view of headband (44) is represented in FIG. 9. It has a Velcro fastening strip (45) on the backside. This strip (45) is fastened to the Velcro fastener (46) as shown in FIG. 10. It is attached to the front side of elastic stretchable band (47) that is attached to the headrest (48) at the backside (49). Elastic stretchable band (47) allows the head to go forward for 5-10 centimeter then stopping it. This prevents strong jerk to the head and the neck during the frontal crash. Top view of the safety seatbelt (50) is represented in FIG. 11, the other end (51) is overlaps at 10 centimeter and away from the seatbelt (50) so, and pressing both the ends stick together at (52). This belt is open instantly by pulling the end. Velcro fastening strip is situated at (52) on seatbelt (50). This is much more convenient and time saving in an emergency compared to the conventional band with a buckle system.

I claim:

1. SAFER CAR comprising of front bumper, strongbox passenger cabin, airbag, head belt, seatbelt wherein
(a) front bumper (1) is connected with front part (2) by strong rod (9) and front part (2) is followed by strongbox passenger cabin (3) which in turn followed by the backside of the car (4);
(b) strong passenger cabin (3) consist front impact beam (18), rear impact beam (19), middle impact beam (20), side impact (21,22,23 &24) and it is connected with chassis of the car plates (25,26,27 & 28);
(c) airbag (37) consists small pipe (38) at the bottom of the dashboard and it has small holes (39,40,41,42 & 43) on the dashboard side;
(d) head band (44) consists Velcro fastening strip (45) is fastened to the Velcro fastener (46) and it is attached to the front side of elastic stretchable band (47) then it is attached to the headrest (48) at the backside (49);
(e) Velcro fastening strip is situated at (52) on seatbelt (50) and the other end (51) is overlaps at 10 centimeter away from the seatbelt (50).

2. SAFER CAR as claimed in claim 1 wherein front bumper (1) is supported by two strong springs (12) and two hydraulic shock absorbers (16 & 17)

3. SAFER CAR as claimed in claim 1 wherein one strong spring (12) is put between the brackets (5 & 6) of the front bumper (1) and other strong spring (12) is put between the brackets (7 & 8) of the front bumper (1).

4. SAFER CAR as claimed in claim 1 wherein strong rod (9) is attached in the middle of the front bumper (1) and the other end of the strong rod (9) is connected with brakes releases system and with liquid Co₂ release system

5. SAFER CAR as claimed in claim 1 wherein the pair of the bracket (10, & 11) encase the cylinder (13) into the front bumper (1).

6. SAFER CAR as claimed in claim 1 wherein one end of the strong spring (12) is encase with cylinder (13) and the other end of the spring is encase with other cylinder (14).

7. SAFER CAR as claimed in claim 1 wherein cylinder (14) is connected with chassis (15) of the safer car.

8. SAFER CAR as claimed in claim 1 wherein lower part of absorber (16) is attached to the cylinder (14).

9. SAFER CAR as claimed in claim 1 wherein upper part of the hydraulic shock absorber (17) is attached with other shock absorber (16).

10. SAFER CAR as claimed in claim 1 wherein each door has one impact beam (34) at the bottom and one impact beam (33) at the middle height.

11. SAFER CAR as claimed in claim 1 wherein pipe (38) at the bottom of the dashboard to allow the liquid Co₂ gas to inflate the airbags in the event of a collision.

12. SAFER CAR substantially as herein described with reference to the foregoing description and the accompanying drawings.
